(19) United States
(12) Patent Application Publication
(10) Pub. No.: US 2005/0128147 A1
(43) Pub. Date: Jun. 16, 2005

(54) Antenna system

(75) Inventor: Khurshid Qureshi, Colorado Springs, CO (US)

Correspondence Address: LAW OFFICE OF DALE B. HALLING, 24 s. WEBER ST., SUITE 311, COLORADO SPRINGS, CO, 80903, US

(73) Assignee: ZeeWaves Systems, Inc.

(21) Appl. No.: 11/011,415

(22) Filed: Dec. 14, 2004

Related U.S. Application Data
(60) Provisional application No. 60/529,851, filed on Dec. 15, 2003.

(51) Int. Cl. H01Q 1/38

(52) U.S. Cl. 343/700 MS

(57) ABSTRACT

A flexible antenna that overcomes these and other problems has a high dielectric substrate with a first surface and a second surface. A reflective material is deposited on the first surface of the high dielectric material. A reflective material s deposited on the second surface of the high dielectric material and antenna arrays are etched on the second surface. Variable radiation patterns are obtained by flexing the antenna.

### RELATED APPLICATIONS

The present invention claims priority on provisional patent application Ser. No. 60/529,851, filed on Dec. 15, 2003, entitled “High Gain Antenna”.

### FIELD OF THE INVENTION

The present invention relates generally to the field of antennas and more particularly to an antenna system.

### BACKGROUND OF THE INVENTION

Wireless networks which includes Wireless Local Area Networks (WLAN), Wireless Wide Area Networks (WWAN), Cellular Networks and satellite communication (SATCOM) are becoming popular. The typical antennas used in these networks are omni directional antennas or bulky dish type directional antennas. Omni directional antennas have low gain and therefore require greater power levels than directional antennas for the same coverage area. In addition, since omni directional antennas transmit in all directions it makes it easy for hackers and ease droppers to listen in on the network or even gain access to the network. Directional antennas have higher gain, but normally there radiation patterns are fixed. As a result, these antennas are more difficult to install and use in a a field or enterprise applications for proper coverage and reduce nulls and blind spots.

Thus there exists a need for antenna system wherein the radiation pattern is not fixed but is adjustable either in the factory or in the field for optimal coverage and gains. At the same time, antenna system should be of lower cost for mass deployment.

### SUMMARY OF INVENTION

A flexible aperture antenna that overcomes these and other problems has a high dielectric substrate with a first surface and a second surface. The first surface is used for reflection and the second surface as a radiator. A reflective material is deposited on the first surface of the high dielectric material. A radiator design is deposited on the second surface of the high dielectric material. The high dielectric material may be of foam or any other polymeric flexible material. A reflection pattern of the antenna remains substantially uniform and proportional as the high dielectric flexible foam is flexed either in the horizontal or vertical axis. A number of radiator designs arrays are deposited on the second surface of the high dielectric flexible foam. The multiple of arrays form a high gain far field pattern. The antenna assembly is held by two vertical bars which are used to flex the antenna by moving them in or out. The assembly can be flexed manually or by use of a servo motor with automatic feed back for proper adjustment of radiation pattern.

In one embodiment, a flexible antenna system has a flexible film antenna. A frame has a pair of bars attached to a pair of sides of the flexible antenna and capable of translating in a plane of the frame. A gain of the flexible film antenna may remains essentially uniform as the flexible film antenna is flexed. The flexible film antenna may have a high dielectric flexible foam with a first surface and a second surface. A reflective material is deposited on the first surface of the high dielectric material. A radiator design is deposited on the second surface of the high dielectric flexible foam. The radiator design may have a number of emitters and a number of signal feeds. A change in an impedance of each of the emitters is equal to the change of an impedance of each of the signal feeds as the radiator design is flexed. A motor may control a position of the pair of bars. A wireless controller may be coupled to the motor.

In one embodiment a flexible antenna system has a high dielectric substrate. A radiator design is deposited on a first surface of the high dielectric substrate. The radiator design may have a number of emitters. The high dielectric substrate may have a reflective second surface. The antenna may be capable of flexing and maintaining an essentially undistorted far field gain pattern. A frame may have a pair of bars attached to a pair of edges of the high dielectric material. The pair of bars may be capable of translating in a plane of the frame. A gain of the antenna is greater than an omni-directional antenna when the antenna is essentially flat.

### BRIEF DESCRIPTION OF THE DRAWINGS

FIG. 1 is an exploded cross sectional view of a flexible antenna in accordance with one embodiment of the invention;

FIG. 2 is a top left perspective view of a frame for holding a flexible antenna in accordance with one embodiment of the invention;

FIG. 3 is cross sectional schematic diagram of the flexible antenna in a flat and a flexed position in accordance with one embodiment of the invention;

FIG. 4 is a radiator design in accordance with one embodiment of the invention;

FIG. 5 is a gain plot of the antenna design using the radiator of FIG. 4 in a flat position in accordance with one embodiment of the invention;

FIG. 6 is a gain plot of the antenna design using the radiator of FIG. 4 in a flexed position in accordance with one embodiment of the invention;

FIG. 7 is a gain plot of the antenna design using the radiator of FIG. 4 in an even more flexed position in accordance with one embodiment of the invention;

FIG. 8 is a schematic diagram of an antenna system in accordance with one embodiment of the invention; and

FIG. 9 is a bottom left perspective of a frame for holding a flexible antenna in accordance with one embodiment of the invention;

FIG. 10 is a side view of the frame for holding a flexible antenna of FIG. 9 in accordance with one embodiment of the invention;

### DETAILED DESCRIPTION OF THE DRAWINGS

The antenna system described herein is inexpensive to manufacture, has a high gain and has a flexible substrate that when flexed changes its gain. The antenna system has a high dielectric flexible foam or polymeric material as a substrate and metallic surfaces deposited on both sides for the for the radiator and reflector functions of the antenna system. A reflective layer is deposited on one surface of the flexible foam. An antenna system is deposited (screen print, sputtered, vapor deposition, etc) on the other surface of the flexible foam. The antenna system may have a number of emitters and a number signal feed paths. The input signal is applied to the signal feed path system and radiator design 20 and the ground or negative input of the input signal is applied to the reflector 18. By designing the emitters and the signal feed paths so that the impedance changes for the emitters are essentially the same as the impedance changes for the feed paths as the antenna system is flexed, it is possible to maintain a substantially uniform and proportional far field gain pattern. A frame and motor are used to flex the antenna. This allows the antenna to have a broader beam width lower gain in one position and a higher gain narrower beam width in a second position. Thus a single antenna can replace multiple antenna designs and shift its gain pattern for the particularly circumstance. An alternate to direct deposition on the foam/polymeric surface is use of polymeric film with metal deposition on both sides.

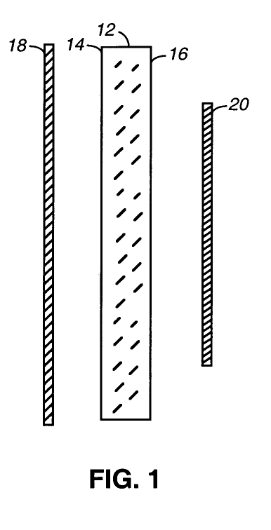

FIG. 1 is an exploded cross sectional view of a flexible antenna 10 in accordance with one embodiment of the invention. The antenna 10 has a high dielectric substrate 12. In one embodiment, the substrate is a high dielectric flexible foam that has a dielectric constant as close to air as possible. Thus “high” as used herein is near or above the dielectric constant of air or a vacuum. The substrate has a first surface 14 and a second surface 16. A reflective material 18 is deposited onto the first surface 14. In one embodiment, the reflective surface 18 is copper or other conductive material. The copper may be deposited by screen printed, sputtered, vapor deposition or any other method. The second surface 16 is deposited with a radiator design 20. The radiator design 20 is also made of a highly conductive material and may be deposited with any known method or may be etched from a solid layer of the conductor. Since, both the reflector 18 and the radiator design 20 are formed on the substrate 12 by automated procedures this is an extremely inexpensive and labor saving method of forming an antenna. In addition, by correctly forming the radiator design 20 the antenna 10 may be flexed and change its gain and beam width characteristics.

In another embodiment, the foam 12 is replaced with an air gap. In this case the reflector 18 and the radiator 20 may be formed on a thin flexible substrate such as a polymeric material. The foam 12 is replaced with spacers that may also be made of foam. The spacers 12, in one embodiment, are small pieces of foam that are used to create the gap 12 between the reflector 18 and the radiator 20.

In another embodiment, the flexible antenna 10 does not have a reflector 18. In this case the radiator 20 may be formed on a thin flexible substrate of the foam 12.

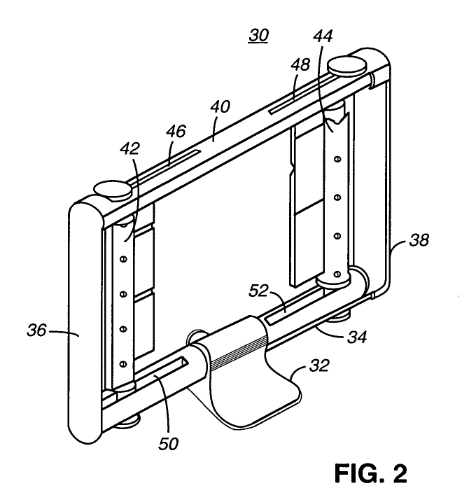

FIG. 2 is a top left perspective view of a frame 30 for holding a flexible antenna in accordance with one embodiment of the invention. The frame 30 has a base 32 and four sides 34, 36, 38, 40. In the top and bottom sides 34 & 40 are placed a pair of moveable bars 42 & 44. The pair of bars 42 & 44 attach to the sides of the antenna. The bars 42 & 44 can move along the slots 46, 48, 50, 52. When the bars are moved along the slots 46, 48, 50, 52, the antenna is flexed and its gain profile is changed.

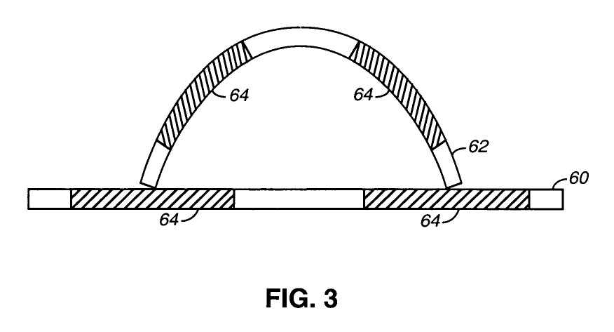

FIG. 3 is cross sectional schematic diagram of the flexible antenna in a flat 60 and a flexed position 62 in accordance with one embodiment of the invention. The section 64 represents the emitters of the antenna. The bars 42 & 44 of FIG. 2 are used to move the flexible antenna between these two positions. Note that the antenna is continuously flexible between these positions. In other embodiments the antenna is allowed to from a tube and have an essentially omni directional gain pattern.

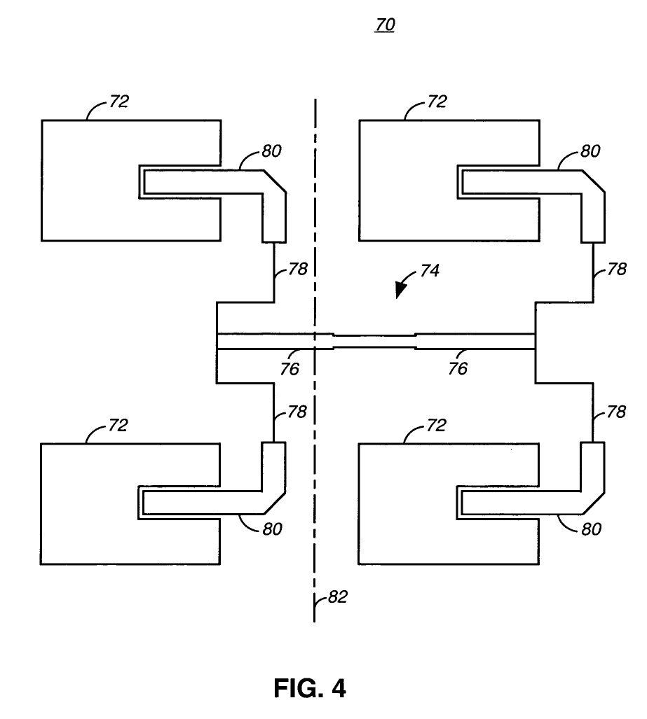

FIG. 4 is a radiator design 70 in accordance with one embodiment of the invention. The radiator design has four identical emitters 72. A signal feed system 74 branches into two arms 76. The two arms 76 connect to four signal traces 78. The four signal traces 78 are coupled to impedance matching traces 80 that apply the signal to the emitters 72. The input signal is applied to the center between the arms 76. The radiator design 70 is designed to flex along the axis 82.

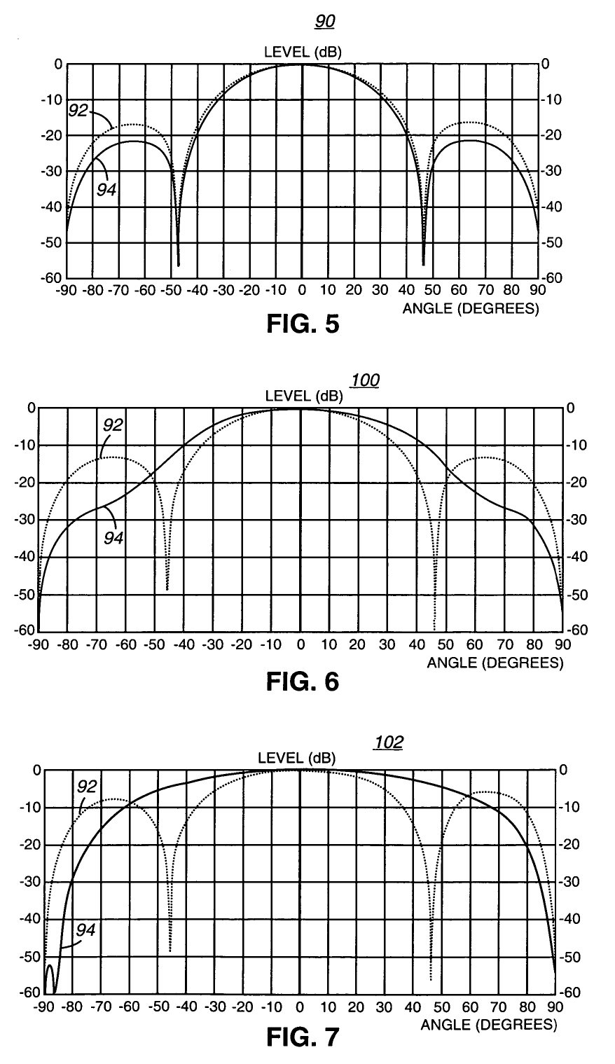

FIG. 5 is a gain plot 90 of the antenna design using the radiator of FIG. 4 in a flat position in accordance with one embodiment of the invention. The plot 90 shows three traces; one for a gain cross section along the x-axis 92, one for a gain cross section along the y-axis (axis 82 in FIG. 4) and one for a gain cross section along the beam axis 94. Note that the section along the beam axis is almost exactly the same as the section along the y-axis for all three FIGS. 5-7. The flat antenna has a beam width of about 36 degrees (slightly larger for the y-axis) and a gain of about 14 dB. FIG. 6 is a gain plot 100 of the antenna design using the radiator of FIG. 4 in a flexed position in accordance with one embodiment of the invention. Note that the x-axis gain 92 has essentially the same profile as in FIG. 5. This makes sense since the antenna is not flexed along the x-axis and therefore the geometrical configuration of the antenna in this axis is essentially undisturbed by the flexing. The beam axis 94 however has been significantly broadened by the flexing of the antenna. The beam width in this example on the beam axis is about 47 degrees and the gain is about 12 dB. As a result, of flexing the antenna the beam width has been expanded about 11 degrees. FIG. 7 is a gain plot 102 of the antenna design using the radiator of FIG. 4 in an even more flexed position in accordance with one embodiment of the invention. In this case the beam width for the on beam axis is about 90 degrees and the gain is about 10 dB. The overall shape of the plot is very similar to that found in FIG. 6. This plots show that the overall gain pattern remains substantially proportional and uniform as the antenna is flexed. In the flat position the antenna is a high gain antenna with a narrow beam width. This reduces the power required by the transmitter and decreases the probability that a hacker can intercept the signal. The antenna also has very high front to back rejection ratio, so very little signal leaks out the backside of the antenna. This also reduces the chance that a hacker can intercept a signal from the antenna.

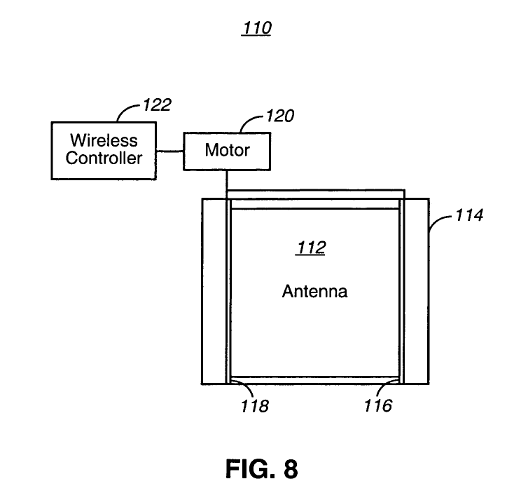

FIG. 8 is a schematic diagram of an antenna system 110 in accordance with one embodiment of the invention. The system 110 has a flexible antenna 112 held by a frame 114. The frame 114 has adjustable bars 116, 118 that are moved by a motor 120. The motor 120 is coupled to a wireless controller 122. This allows the antenna shape and gain profile to be adjustable remotely.

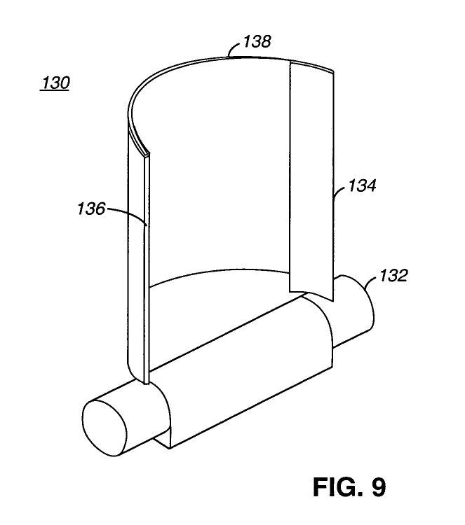

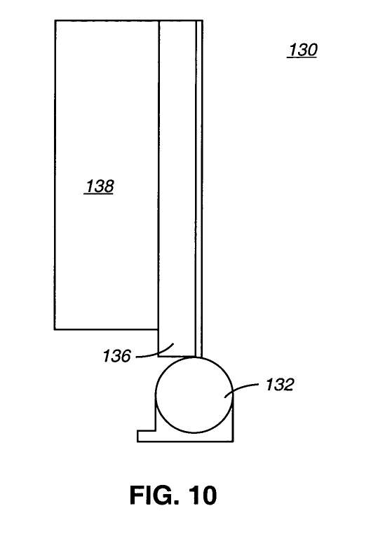

FIG. 9 is a bottom left perspective of a frame for holding a flexible antenna 130 in accordance with one embodiment of the invention. The frame 132 is a pivoting cylinder. A pair of posts 134, 136 hold the edges of the flexible antenna 138. The posts 134, 136 may be manually moved towards each other to cause the antenna 138 to flex. FIG. 10 is a side view of the frame for holding a flexible antenna of FIG. 9 in accordance with one embodiment of the invention. This view shows that the antenna sytem 130 may be rotated about the cylinder 132. In one embodiment the rotation of the antenna 138 in the cylinder 132 has a plurality of set positions. The positions may be spaced every 20 degrees in one embodiment.

Thus there has been described an antenna that is very inexpensive to manufacture. By selecting the correct antenna design, the antenna may be flexed to obtain a different gain profile. The antenna provides a higher gain than the present omni directional antennas used in wireless networks. As a result, the power required by the transmitter is reduced and there is a low probability of intercept by hacker or eavesdroppers.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A flexible antenna, comprising:
a high dielectric space having a first surface and a second surface;
a reflective material deposited on the first surface of the high dielectric material; and
a radiator design deposited on the second surface of the high dielectric material.

2. The antenna of claim 1, wherein the high dielectric space is a high dielectric flexible foam.

3. The antenna of claim 2, wherein a gain pattern of the antenna remains substantially uniform and proportional as the high dielectric flexible foam is flexed.

4. The antenna of claim 2, wherein a plurality of radiator designs are deposited on the second surface of the high dielectric flexible foam.

5. The antenna of claim 4, wherein the plurality of radiator designs form a high gain radiation pattern in the far field.

6. The antenna of claim 4, further including a frame having a pair of bars attached to two edges of the high dielectric flexible foam, the pair of bars capable of translating in a plane of the frame.

7. The antenna of claim 6, wherein the bars are moved by a motor.

8. A flexible antenna system, comprising:
a flexible film antenna; and
a frame having a pair of bars attached to a pair of sides of the flexible antenna and the pair of bars are capable of translating in a plane of the frame.

9. The antenna system of claim 8, wherein a gain of the flexible film antenna remains essentially uniform as the flexible film antenna is flexed.

10. The antenna system of claim 9, where the flexible film antenna comprises:
a high dielectric flexible foam having a first surface and a second surface;
a reflective material deposited on the first surface of the high dielectric material; and
a radiator design deposited on the second surface of the high dielectric flexible foam.

11. The antenna system of claim 10, wherein the radiator design has a plurality of emitters and a plurality of signal feeds.

12. The antenna system of claim 11, wherein a change an impedance of each of the plurality of emitters is equal to the change of an impedance of each of the plurality of signal feeds as the radiator design is flexed.

13. The antenna system of claim 8, further including a motor controlling a position of the pair of bars.

14. The antenna system of claim 13, further including a wireless controller coupled to the motor.

15. A flexible antenna system, comprising:
a high dielectric substrate; and
a radiator design deposited on a first surface of the high dielectric substrate.

16. The antenna system of claim 15, wherein the radiator design has a plurality of emitters.

17. The antenna system of claim 16, wherein the high dielectric substrate has a reflective second surface.

18. The antenna system of claim 17, wherein the antenna is capable of flexing and maintaining an essentially undistorted far field gain pattern.

19. The antenna system of claim 17, further including a frame having a pair of bars attached to a pair of edges of the high dielectric material, the pair of bars capable of translating in a plane of the frame.

20. The antenna system of claim 16, wherein a gain of the antenna is greater than an omni-directional antenna when the antenna is essentially flat.

21. The antenna system of claim 2 where air gap or some other high dielectric material such as polymers or fiberglass or similar material is used as spacer to acquire optimum antenna characteristics.

22. The antenna system of claim 2 where an antenna made on a film is molded on a surface or embedded in an enclosure.
